(19) United States
(12) Patent Application Publication
(10) Pub. No.: US 2026/0296147 A1
(43) Pub. Date: Oct. 1, 2026

(54) WINDSHIELD SYSTEM FOR KEEPING DEBRIS AWAY AND REMOVING DEBRIS FROM ITS OUTER SURFACE

(71) Applicant: Deda Grishaj, Yonkers, NY (US)

(72) Inventor: Deda Grishaj, Yonkers, NY (US)

(21) Appl. No.: 19/636,533

(22) Filed: Apr. 1, 2026

Related U.S. Application Data
(60) Provisional application No. 63/781,564, filed on Apr. 1, 2025.

(51) Int. Cl. B60J 1/20; B60S 1/54

(52) U.S. Cl. CPC B60J 1/2094; B60S 1/54

(57) ABSTRACT

The present invention provides a windshield system for keeping debris away from the windshield. According to an embodiment, the system includes an outer glass surface having a first shape and including a plurality of micro-holes therethrough and a solid inner glass surface having a second shape substantially the same as the first shape and being positioned behind the outer surface. The inner surface is sealably connected to the outer surface along each of a plurality of edges to form one or more sealed chambers between the outer and inner surfaces such that air between the outer and inner windshield surfaces can only escape through the micro-holes. The system further includes one or more openings on a given one of the plurality of edges configured to accept one or more nozzles which are configured to supply the one or more chambers with pressurized air which is forced through the micro-holes.

### RELATED APPLICATIONS

This application claims priority to U.S. Provisional Patent Application No. 63/781,564 filed on Apr. 1, 2025, entitled “SYSTEM AND METHOD FOR REMOVING DEBRIS FROM A SURFACE”, which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records but otherwise reserves all copyright rights whatsoever.

### BACKGROUND

This application relates to a system and method for preventing and/or removing rain and other forms of precipitation from an exterior windshield, and for self-cleaning a window or windshield.

Traditional systems and methods for removing precipitation from a windshield have included windshield wipers and air blowers/fans located on the outside of a windshield and configured to blow air toward the windshield surface. Windshield wipers are prone to breakage, may have limited effectiveness, and provide suboptimal visibility. Air jets/blowers blowing air at a windshield also have limited effectiveness in improving visibility. There is a need in the art for a system and method for more efficiently blowing away, removing, and/or preventing rain and other forms of precipitation from a surface to provide optimal visibility through the surface.

### SUMMARY

The present invention provides a windshield system for keeping rain and debris away or removing rain or other forms of precipitation or debris from the windshield. According to an embodiment, the system comprises an outer glass surface of the windshield having a first shape and comprising a plurality of micro-holes therethrough. The system further comprises a solid inner glass surface of the windshield having a second shape substantially the same as the first shape, the solid inner surface being positioned behind the outer surface. The solid inner surface is sealably connected to the outer surface along each one of a plurality of edges to form one or more sealed chambers between the outer and solid inner surfaces such that air between the outer and inner windshield surfaces can only escape through the micro-holes. The system further comprises one or more openings on one of the plurality of edges, wherein the one or more openings are configured to accept one or more nozzles to supply the one or more sealed chambers with pressurized air which is forced through the micro-holes to thereby force debris away from or off the outer surface.

In an embodiment, the pressurized air may flow into the one or more chambers and out through the plurality of micro-holes, forming a barrier layer of pressurized air surrounding the outer surface. The outer surface may further comprise a plurality of macro-holes therethrough each having a diameter between 550 μm to 1000 μm. Each one of the micro-holes may have a diameter between 50 μm to 500 μm. The windshield system may comprise a plurality of sealed chambers and a plurality of nozzles, each nozzle being configured to supply pressurized air to a respective one of the sealed chambers.

In an embodiment, a sensor may be positioned on or near the windshield to detect debris on or in proximity to the outer surface of the windshield. The pressurized air may be automatically pumped through the one or more nozzles via an air pump coupled to the one or more nozzles based on the sensor's detection of debris on or in proximity to the outer surface. In an embodiment, a plurality of sensors may be positioned at different locations on or near the windshield to detect debris or precipitation on or in proximity to the outer surface of the windshield at the different locations. The pressurized air may be supplied at varying speeds and/or pressures in response to the amount of debris detected by the sensor. The pressurized air may be selectively heated or cooled to facilitate removal of precipitation from the outer surface.

In an embodiment, a windshield system for keeping debris away or removing debris from the windshield is disclosed. The system comprises an outer glass surface of the windshield having a first shape and comprising a plurality of through-holes. The system further comprises a solid inner glass surface of the windshield having a second shape substantially the same as the first shape. The solid inner surface is positioned behind the outer surface and is sealably connected to the outer surface along each of a plurality of edges to form one or more sealed chambers between the outer and solid inner surfaces. Air between the outer and inner windshield surfaces can only escape through the through-holes. The system further comprises an air pump coupled to one or more nozzles that is situated in one or more openings on a given one of the plurality of edges. The air pump is configured to supply pressurized air to the one or more sealed chambers through the one or more nozzles such that the pressurized air is forced through the through-holes to thereby force debris away from or off the outer surface.

In an embodiment, the plurality of through-holes may comprise a plurality of micro-through-holes and/or a plurality of macro-through-holes. The micro-through-holes each has a diameter between 50 μm to 500 μm and the macro-through-holes each has a diameter between 550 μm to 1000 μm. The pressurized air may flow into the one or more chambers and out through the plurality of through-holes, forming a barrier layer of pressurized air surrounding the outer surface. The windshield system may comprise a plurality of sealed chambers and a plurality of nozzles, each nozzle being configured to supply pressurized air to a respective one of the sealed chambers.

In an embodiment, the system comprises a sensor positioned on or near the windshield to detect debris on or in proximity to the outer surface of the windshield. The pressurized air may be automatically pumped through the one or more nozzles based on the sensor's detection of debris on or in proximity to the outer surface.

In an embodiment, a plurality of sensors is positioned at different locations on or near the windshield to detect debris or precipitation on or in proximity to the outer surface of the windshield at the different locations. The pressurized air may be selectively heated or cooled to facilitate removal of precipitation the outer surface. The air pump may be automatically activated in response to the amount of debris detected by the sensor. The pressurized air may be supplied at varying speeds and/or pressures in response to the amount of debris detected by the sensor.

According to an embodiment, a method for keeping debris away or removing debris from a windshield is disclosed. The method comprises detecting, by a sensor positioned on or near the windshield, an amount of debris on or in proximity to an outer glass surface of the windshield. The outer surface comprises a plurality of micro-holes therethrough. The outer surface is sealably connected to a solid inner glass surface along each of a plurality of edges to form one or more sealed chambers between the outer and solid inner surfaces such that air between the outer and inner windshield surfaces can only escape through the micro-holes. The method further comprises determining, by a controller, that the amount of debris meets a given threshold and activating, by the controller, an air pump based at least on the determination. The air pump is coupled to one or more nozzles which are situated in one or more openings on one of the plurality of edges. The method further comprises supplying, by the air pump, pressurized air into the one or more sealed chambers and out through the micro-holes to form a barrier layer of pressurized air on the outer surface.

In an embodiment, the micro-holes may each have a diameter between 50 μm to 500 μm. The outer glass surface may have a first shape and be sealably connected to a solid inner glass surface that is positioned behind the outer surface. The solid inner glass surface may have a second shape substantially the same as the first shape.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is an isometric view of a system for removing debris from a surface and preventing debris from contacting a surface according to an embodiment;

FIG. 2 is a front view of a system for removing debris from a windshield of a vehicle and preventing debris from contacting the windshield according to an embodiment;

FIG. 3A is a microscopic view of micro-through-holes having a diameter of 300 μm according to an embodiment;

FIG. 3B is a microscopic view of a micro-through-hole shown to a 50 μm scale according to an embodiment;

FIG. 3C is a microscopic view of micro-through-holes shown to a 100 μm scale according to an embodiment;

FIG. 3D is a microscopic view of micro-through-holes shown to a 10 μm scale according to an embodiment;

FIG. 4 is a microscopic view of micro processing through glass according to an embodiment;

FIG. 5 is an isometric view of micro-through-holes to scale compared to a quarter according to an embodiment; and

FIG. 6 is a diagram of an example process for removing debris from a surface according to an embodiment.

FIG. 7 is an exploded perspective view of a system for removing and preventing debris from contacting a windshield showing multiple panes arranged in a layered configuration according to an embodiment.

FIG. 8 is an isometric view of a system for removing and preventing debris from contacting a windshield according to an embodiment.

FIG. 9 illustrates multiple zones of a system for removing and preventing debris from contacting a windshield according to an embodiment.

FIG. 10 illustrates multiple zones and tunnels of a system for removing and preventing debris from contacting a windshield according to an embodiment.

FIG. 11 is an isometric side view of a system for removing and preventing debris from contacting a windshield according to an embodiment.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

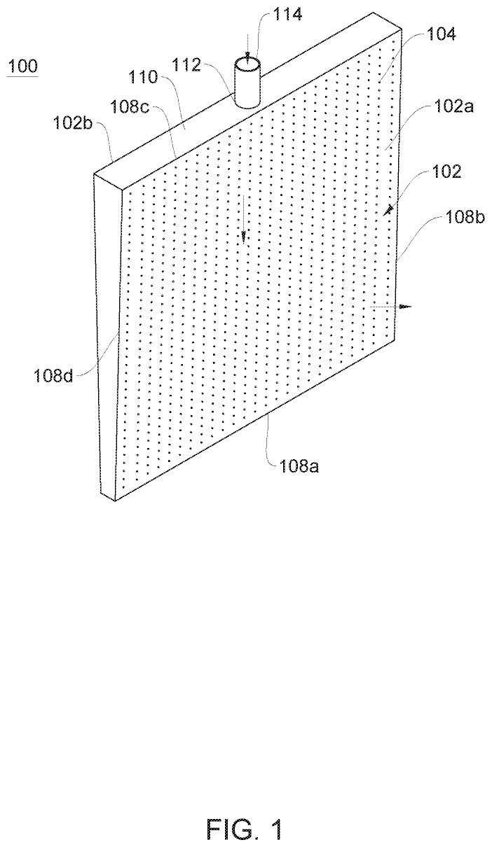

With reference to FIG. 1, the present invention provides a windshield system 100 for keeping rain, other forms of precipitation, or debris away from a surface 102 or for removing rain, other forms of precipitation, or debris from surface 102. Surface 102 can be any type of surface including but not limited to a windshield on one or more vehicles, some examples being a car, train, boat, and airplane. Other examples of surface 102 may include windows of buildings or other structures, or the visor or windshield of a helmet. Additional examples may include optical or transparent surfaces such as camera or microscopic lenses, sensor covers, optical panels, skylights, protective shields, instrument panels, or transparent covers for lighting, imaging, or monitoring devices. In some embodiments, system 100 can be used with surfaces associated with equipment requiring a constant clear view, including but not limited to, lenses or viewing elements of cameras, microscopes, or military equipment (e.g., firearm scopes or protective eyewear).

According to an embodiment, system 100 comprises an outer surface 102a including one or more micro-through-holes 104 therethrough in a first plane and a solid (e.g., including no micro-through-holes therethrough) inner surface 102b in a second plane parallel to the first plane. As used herein, surfaces described as “parallel” may include curved surfaces that are equidistant or maintain a generally uniform spacing from one another (e.g., two similarly shaped curved surfaces such as windshield layers). In some embodiments, the surfaces may be substantially or approximately parallel, meaning that the spacing between the surfaces may remain generally consistent even if the surfaces are curved or exhibit minor variations in shape. Accordingly, the surfaces need not be perfectly parallel or equidistant along their entire extent, and some variability in spacing, curvature, or contour may be present while still falling within the scope of the invention.

The outer surface 102a can be configured to be exposed to the elements (e.g., facing the environment outside). The solid inner surface 102b can be configured to face an interior space (e.g., of a vehicle, building or helmet). Any suitable material for the outer and inner surfaces are contemplated herein. For example, the inner and outer surface can be glass or any other transparent material, including but not limited to polymers (e.g., macromolecules formed by repeating monomers), plexiglass, and transparent aluminum.

In an embodiment, outer surface 102a may comprise one or more through-holes comprising micro-through-holes 104 (for example, each micro-through-hole having a diameter between 50 μm to 500 μm) and/or macro-through-holes (for example, each macro-through-hole having a diameter between 550 μm to 1000 μm).

The outer surface 102a and the solid inner surface 102b are connected (e.g., sealably, removably or permanently) to each other on all sides (or edges) 108a-108d forming one or more sealed chambers 110 therebetween. As used herein, the term “sealed chamber” refers to a chamber that is substantially sealed along its sides or perimeter such that air, gas, or other fluids within the chamber are substantially prevented from escaping laterally between the surfaces forming the chamber. Air, gas, gas mixtures, or other fluids within the chamber are thus directed to exit through the through-holes rather than through gaps at the sides or perimeter of the chamber. In some embodiments, system 100 may be configured to operate across a wide range of temperatures, including extreme low and high temperature environments.

The outer surface 102a and solid inner surface 102b can be any shape and can include any number of sides. In some embodiments, outer surface 102a has a first shape and solid inner surface 102b has a second shape that is substantially the same as the first shape. Solid inner surface 102b is positioned behind outer surface 102a. In some embodiments, the space between outer surface 102a and solid inner surface 102b (e.g., that forms chamber 110) can be between 0.2 to 1.0 inches. According to an embodiment, system 100 may comprise additional planes comprising one or more micro-through-holes and/or one or more macro-through-holes. The additional planes may be situated between the first plane and the second plane, thereby creating two or more chambers therebetween.

The one or more micro-through-holes 104 can be configured to extend through the outer surface 102a connecting an outer environment to the chamber 110 such that pressurized air can be forced out from chamber 110 through the micro-through-holes 104 towards the outer environment. In an embodiment, the air between outer surface 102a and inner surface 102b can only escape chamber 110 through micro-through-holes 104 and thereby force debris away from or off outer surface 102a. Any suitable number of micro-through-holes 104 is contemplated herein. The micro-through-holes can be small enough to prevent and remove debris (e.g., precipitation, mud, dirt, etc.) from entering the sealed chamber, but large enough to allow pressurized air to escape, thereby forming the pressurized air barrier layer surrounding the entirety of the outer surface 102a. In some embodiments, the pressurized air can be hot compressed air, cold compressed air, or compressed air of any selected temperature.

In some embodiments, the through-holes 104 (e.g., micro-perforations or micro-apertures extending through outer surface 102a) can be laser drilled through-holes that can be 1,000 micrometers in diameter. Laser micro-drilling processes are disclosed in International Patent No. 2022/175507, International Patent No. 2024/087248, German Patent No. 102015218760, U.S. Patent Application Publication No. 2010/0062214, and U.S. Pat. No. 6,610,960, all of which are incorporated by reference in their entirety. Micro-drilled holes can be sized between a microscopic and macroscopic range (e.g., not visible to the human eye).

The system 100 also comprises one or more openings 112 on one of the sides (for example, side 108c) configured to accept one or more nozzles 114. The opening 112 can be placed on any side of the surface 102 or where outer surface 102a and solid inner surface 102b meet. The nozzle 114 can be connected to a source of pressurized air (e.g., pressure line adapter). The nozzle 114 is configured to supply the chamber 110 with pressurized air (e.g., the flow of pressurized air is shown by the arrows in FIG. 1). In some embodiments, the nozzle 114 can include one or more nozzles. The one or more nozzles can be connected to the corners or edges of the sides of the surface 102 or on the surface 102 itself. In embodiments where system 100 comprises more than one chamber 110, each nozzle 114 is configured to supply pressurized air to a respective one of the chambers 110. In some embodiments, the nozzle 114 can be any other shape than what is shown in FIG. 1 (e.g., a rail shape).

In certain embodiments, the nozzle 114 can be fitted for a pipe that is connected to an air pump or compressor motor. The air pump or compressor motor can be actuated by a pulley moving on a serpentine belt. Any other means of supplying pressurized air to a nozzle are contemplated herein. For example, pressurized air can be supplied by a fan (e.g., centrifugal or axial fans), an air blower (e.g., centrifugal blower, axial flow blower, or positive displacement blower), or a compressor (e.g., positive displacement compressor or dynamic compressor).

In some embodiments, the pressurized air flows into the chamber 110 through the opening 112 then through the one or more micro-through-holes 104. This forms a barrier layer of pressurized air surrounding the entirety of the surface 102. The barrier of pressurized air can prevent debris from contacting the surface 102 and can remove any type of debris from the surface 102. Debris can include, but is not limited to rain, snow, ice, other precipitation, mud, dirt, leaves, and insects. Debris may further include particles across a spectrum of sizes and weights (for example, lightweight particulate matter such as dust, as well as heavier contaminants such as mud or dirt).

In some embodiments, system 100 may further include a heating element configured to heat the pressurized air before it flows into chamber 110 and through the micro-through-holes 104 of outer surface 102a. The heated air may be emitted through the micro-through-holes 104 toward outer surface 102a such that precipitation contacting outer surface 102a is heated. In certain embodiments, the emitted heated air may raise the temperature at or near outer surface 102a sufficiently to melt frozen precipitation (e.g., snow or ice) and/or vaporize liquid precipitation (e.g., rain or water droplets). As a result, the heated airflow may assist in preventing accumulation of precipitation on surface 102 and may thereby improve visibility. In an embodiment, the heated airflow may also evaporate moisture buildup on surface 102, thereby reducing or eliminating fogging (e.g., defogging the windshield or other transparent surface).

In certain embodiments, the system not only prevents debris from contacting the surface 102 but can also remove any debris that contacts the surface 102. For example, the pressurized air barrier layer may deflect or disperse incoming droplets or debris before they adhere to surface 102, thereby reducing accumulation of precipitation, contaminants, or other elements. In some embodiments, the system can clean the surface 102 if debris contacts the surface 102. For example, if debris accumulates while the system 100 is not in use, upon using the system 100, any accumulated debris can be removed and cleaned from the surface 102.

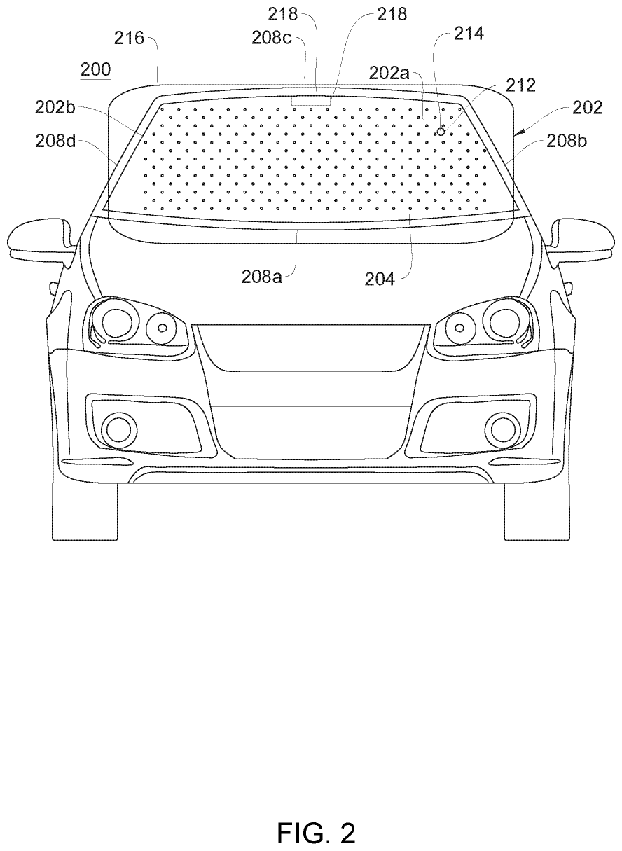

With reference to FIG. 2, elements corresponding to elements shown in FIG. 1 are designated by reference numerals in the 200 series (e.g., element 202 corresponds to element 102, element 204 corresponds to element 104, etc.). In some embodiments, the surface 202 can be a windshield of a vehicle 200 (e.g., car, train, bus, plane, etc.). The outer surface 202a including the micro-holes 204 therethrough can be a part of the exterior of the vehicle 200 facing an outdoor environment. The solid inner surface 202b can be behind the outer surface 202a and in contact with the interior of the vehicle 200. The inner surface 202b is solid to protect the interior of a vehicle 200 from the elements outside of the vehicle 200. Pressurized air can flow through an opening 212 to a nozzle 214 from a pressurized air source into the sealed chamber (e.g., as shown in FIG. 1) between the outer surface 202a and inner surface 202b. The pressurized air may be forced through the micro-through-holes 104 towards the outside of the vehicle 200, creating a pressurized air barrier layer 216 around the outside of the windshield 202. As a result, debris (e.g., precipitation, mud, dirt, bugs, etc.) is prevented from contacting the windshield 202 and can be removed from the windshield 202. This creates clear visibility for those operating the vehicle 200. All features of the system 100 as described above with respect to FIG. 1 are readily applied to the system as described in FIG. 2.

The nozzle 214 can be located on any side 208a-208d of the surface 202 of the vehicle 200. As shown in FIG. 2, the air nozzle 214 is shown on side 208b of the surface 202 of the vehicle 200. Pressurized air supplied through the nozzle 214 into the chamber can be supplied manually or automatically as described above with reference to FIG. 1.

In some embodiments, the pressurized air can be supplied manually. For example, a user can turn the pressurized air supply on/off manually and can adjust the speed/pressure of the pressurized air supply based on current conditions (e.g., heavy precipitation versus lighter precipitation).

In other embodiments, the pressurized air can be supplied automatically. For example, the pressurized air flow can be supplied automatically based on detection of debris surrounding the surface. System 100 may include one or more sensors 218 positioned at different locations on or near the windshield/surface 102. Sensors 218 are configured to detect debris, precipitation, or other contaminants in proximity to surface 102. In some embodiments, sensors 218 may include one or more optical sensors, infrared sensors, moisture sensors, rain sensors, particulate sensors, cameras, or other environmental sensing devices capable of detecting the presence or accumulation of debris or precipitation on or near surface 102. Such sensors are well known in the art and may include commercially available sensing devices configured to monitor environmental conditions in proximity to surface 102.

In certain embodiments, sensors 218 may generate signals indicative of the presence, amount, or density of debris or precipitation, which may be communicated to a controller configured to automatically initiate or adjust the pressurized airflow supplied into chamber 110 to assist in removing the detected debris. The speed and pressure of the pressurized air supply can also be controlled automatically based on the detected debris. For instance, when heavier levels of debris are detected, the pressurized air supply can automatically operate at a higher speed and pressure. The pressurized air can also be selectively heated or cooled to facilitate removal of precipitation or debris from outer surface 102a.

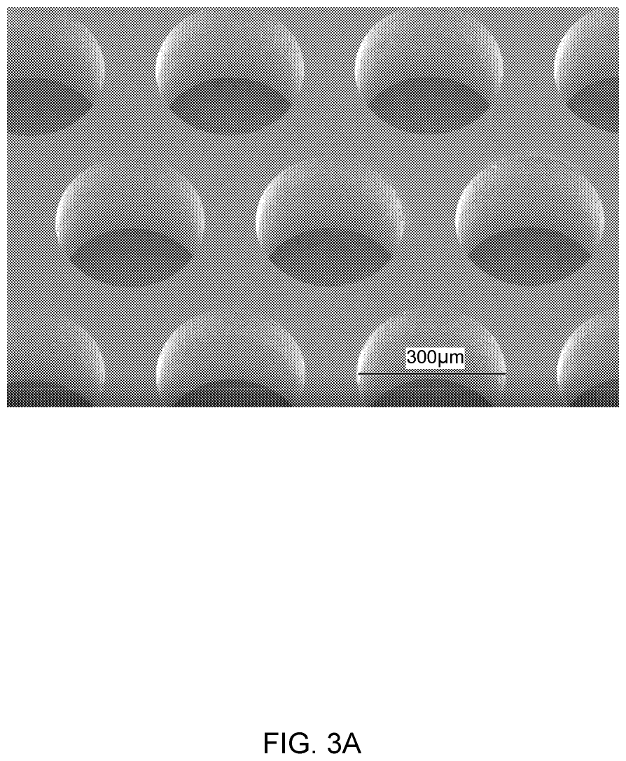

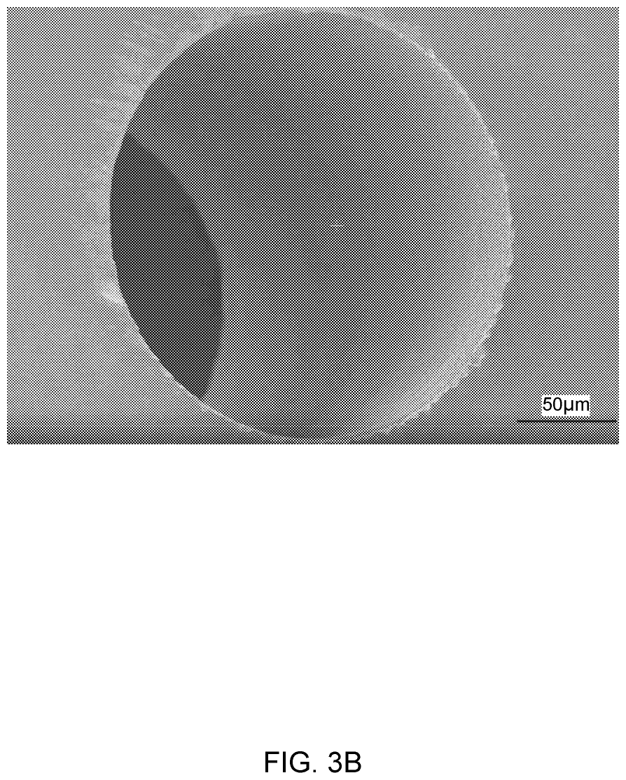

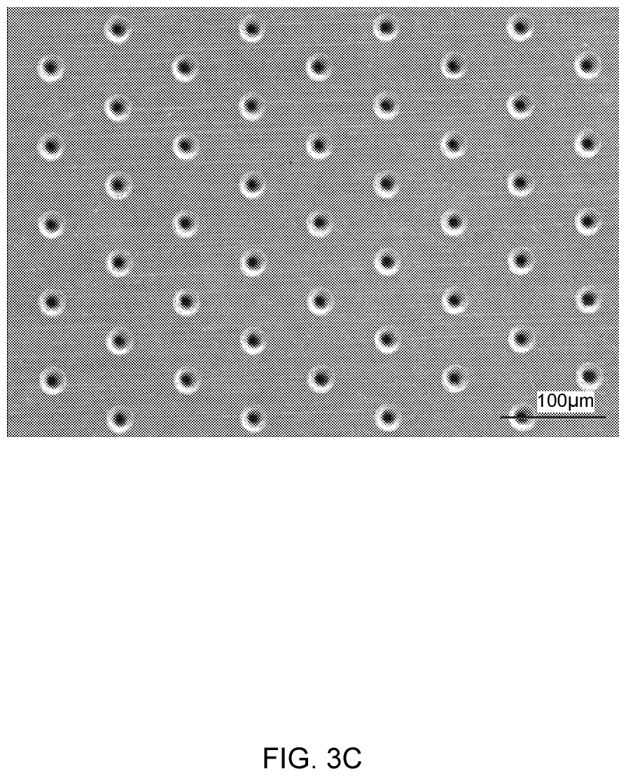

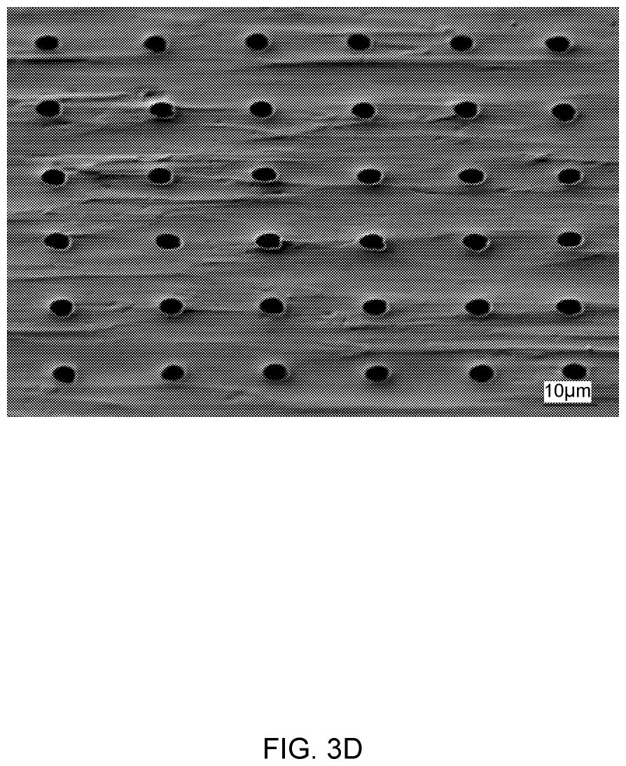

With reference to FIGS. 3A-3D, various exemplary micro-drilled through-holes are shown. These micro-drilled through-holes may correspond to micro-through-holes 104 and 204. For example, in FIG. 3A, glass micro-drilled through-holes having a diameter of 300 μm with no taper are shown. In FIG. 3B, an obsidian (SiO2) micro-drilled through-hole without taper is shown to a 50 μm scale. In FIG. 3C, micro-drilled through-holes to a 100 μm scale are shown. In FIG. 3D, micro-drilled through-holes to a 10 μm scale are shown. The images provided in FIGS. 3A-3D are from Workshop of Photonics and are provided at the following link: https://wophotonics.com/services/glass-micro-drilling/.

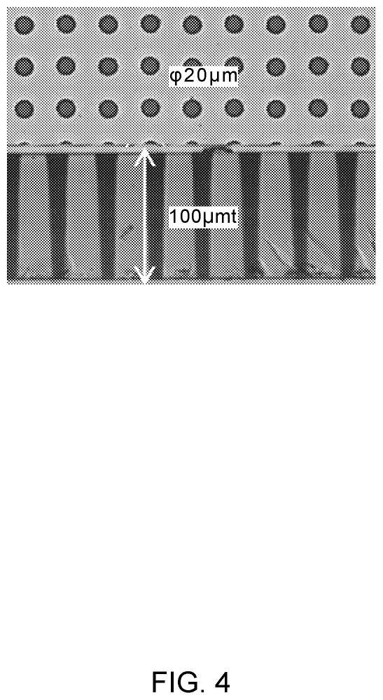

With reference to FIG. 4, an exemplary embodiment of micro-through-hole drilling through glass is shown. The micro-drilled through-holes are shown to a 20 μm scale having a depth of 100 μmt and may correspond to micro-through-holes 104 and 204. The image provided in FIG. 4 is from AGC and is provided at the following link: https://www.agc.com/en/products/electoric/detail/tgv.html.

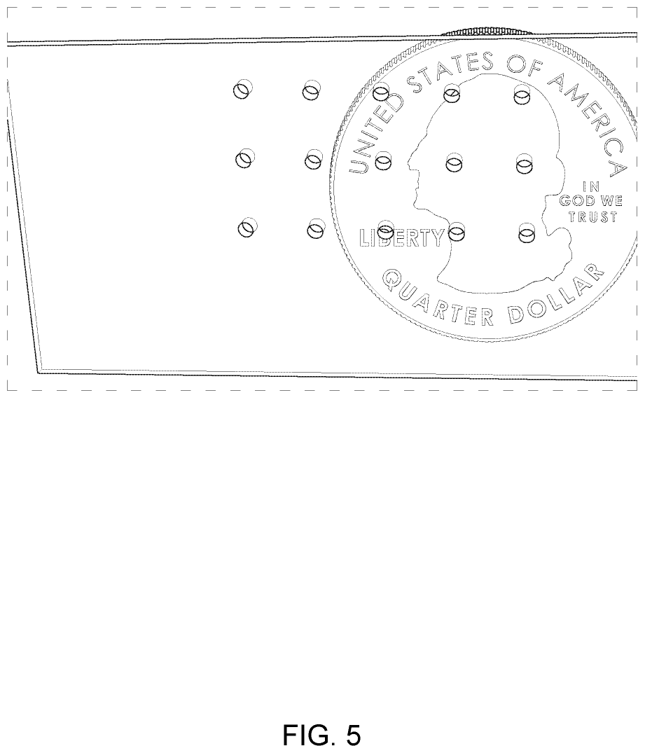

With reference to FIG. 5, an exemplary embodiment of micro-drilled through-holes is shown, where the micro-drilled through-holes are shown through a transparent material to scale as compared to a quarter. These micro-drilled through-holes may correspond to micro-through holes 104 and 204. The image provided in FIG. 5 is from Potomac and is provided at the following link: https://www.potomac-laser.com/project-gallery/small-holes-in-glass/. The images shown in FIGS. 3A-5 are shown for exemplary purposes only and are not meant to be taken in a limiting sense.

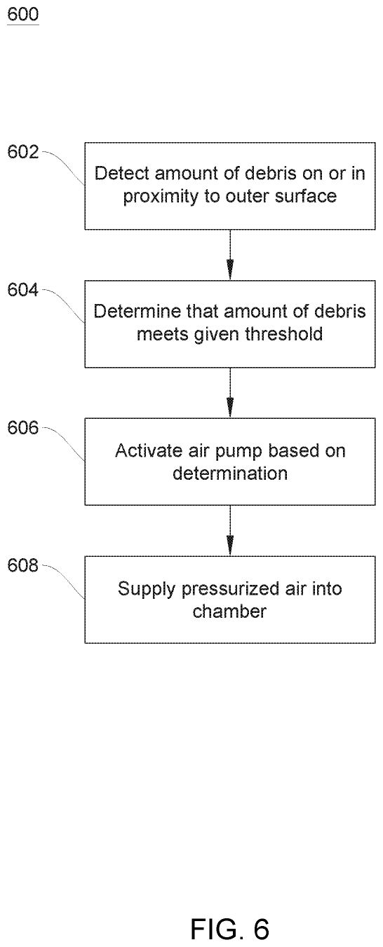

With reference to FIG. 6, a method 600 for keeping debris away or removing debris from a windshield in accordance with some embodiments will now be described. The process of FIG. 6 comprises steps 602 through 608 and is suitable for use in system 100 but is more generally applicable to other types of systems for preventing and removing debris from a surface. The steps of method 600 reference elements identified by the reference numerals shown in FIG. 1. These elements may also appear in other figures and correspond to the same components described herein.

At step 602, one or more sensors 218 positioned on or near the windshield detect an amount of debris on or in proximity to outer surface 102a. As described above, outer surface 102a comprises one or more micro-through-holes 104 therethrough and is sealably connected to solid inner surface 102b along each one of a plurality of sides (or edges) 108a-108d to form sealed chamber 110. In an embodiment, micro-through-holes 104 may have a diameter between 50 μm to 500 μm. Outer surface 102a may further comprise one or more macro-through-holes with a diameter between 550 μm to 1000 μm. Air between outer surface 102a and inner surface 102b can only escape through micro-through-holes 104 or macro-through-holes, if present. In an embodiment, outer surface 102a has a first shape and inner surface 102b, which is positioned behind outer surface 102a, has a second shape that is substantially the same as the first shape.

At step 604, a controller determines that the amount of debris detected on or in proximity to outer surface 102a meets a given threshold. In some embodiments, the threshold may correspond to a predetermined amount, density, concentration, or coverage of debris detected on or near outer surface 102a. For example, the threshold may be based on a measured level of particulate matter, a number of detected debris particles, a percentage of surface coverage by debris, a detected level of precipitation, or a reduction in optical clarity or visibility through outer surface 102a. The threshold may be monitored using one or more sensors 218 positioned on or in proximity to outer surface 102a, such as optical sensors, cameras, particulate sensors, moisture sensors, rain sensors, or other environmental sensing devices. In some embodiments, the controller may continuously or periodically evaluate signals from the sensors 218 and compare the detected debris level to the predetermined threshold to determine whether activation or adjustment of the pressurized airflow is required.

At step 606, the controller activates an air pump based at least on the determination that the amount of detected debris meets the threshold. The air pump is removably coupled to nozzle 114 which is situated in opening 114 on a given one of the plurality of sides 108a-108d. The pressurized air may be supplied at varying speeds and/or pressures and may be selectively heated or cooled to facilitate removal of precipitation or debris from outer surface 102a. The speed, pressure, and/or temperature of the pressurized air may be adjusted based on the detected amount of debris or precipitation, such that higher levels of detected debris may cause system 100 to increase the airflow speed, pressure, and/or temperature to enhance removal from outer surface 102a. In an embodiment, the air pump may comprise a compressor motor or any other means of supplying pressurized air to a nozzle which are discussed above.

At step 608, the air pump supplies pressurized air into chamber 110. The pressurized air then flows out through the one or more micro-through-holes 104 to form a barrier layer of pressurized air on outer surface 102a.

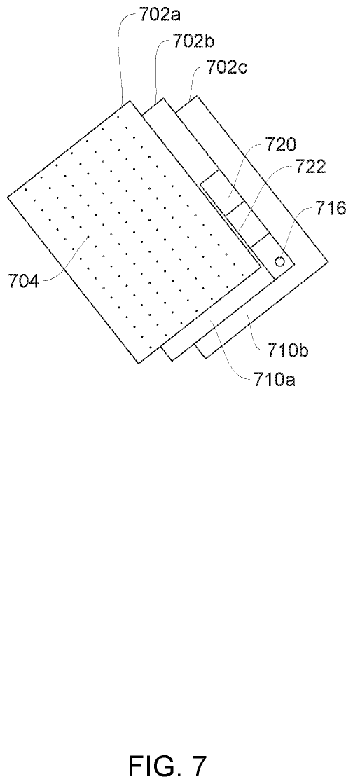

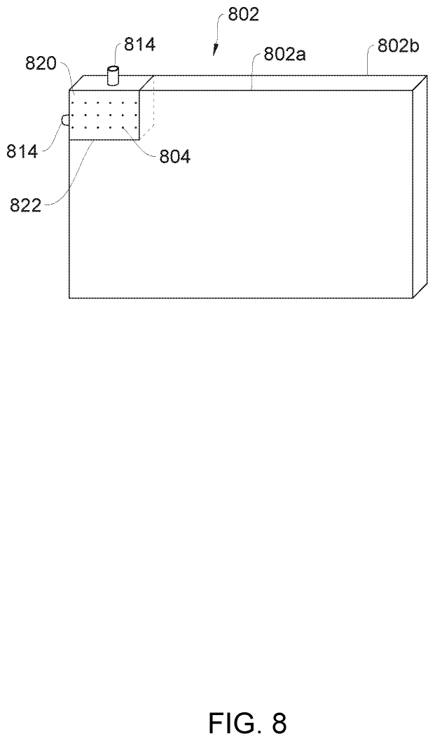

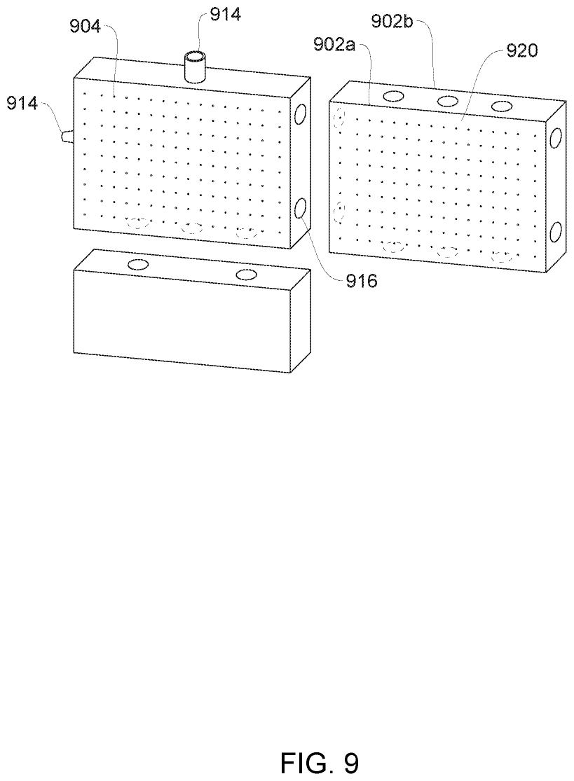

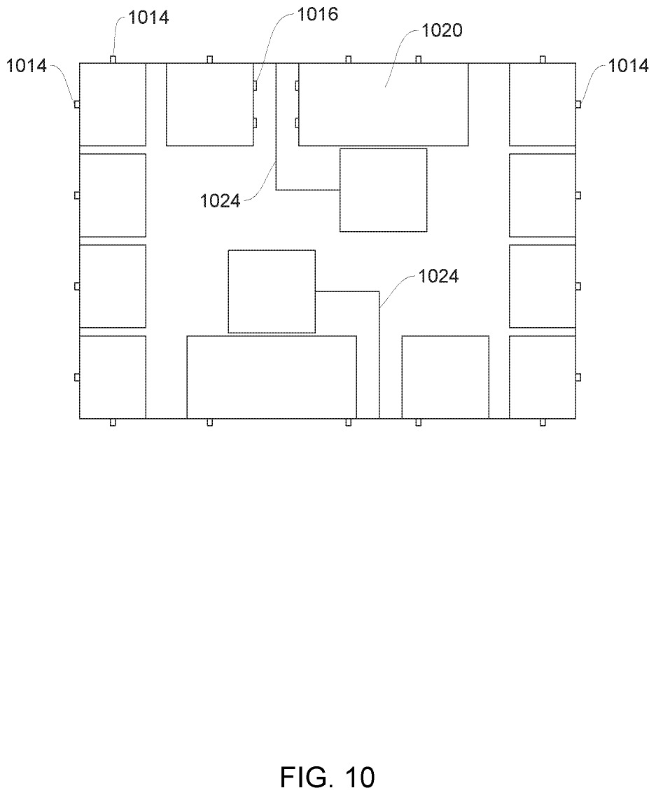

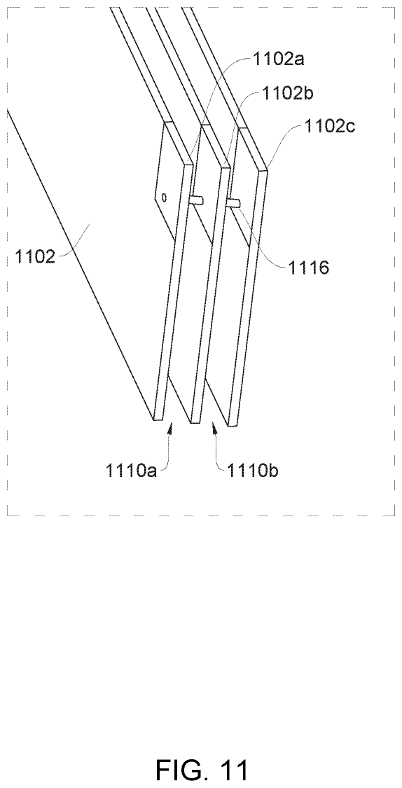

With reference to FIGS. 7-11, elements corresponding to elements shown in FIGS. 1 and 2 are designated by reference numerals in the 700-1100 series, and like elements across the figures are indicated by corresponding reference numerals (e.g., elements 102, 202, 702, 802, 902, 1002, and 1102 correspond to one another; elements 104, 204, 704, 804, 904, 1004, and 1104 correspond to one another; etc.). In some embodiments, system 100 may include multiple surfaces (or panes) 102 arranged in a layered configuration (e.g., three, four, five, or more panes), thereby forming multiple chambers 710a, 710b between adjacent panes. Each of the panes may be solid or may include one or more through-holes. For example, in a three-pane configuration, two inner panes (702b and 702c) may be solid while an outer pane (702a) includes through-holes 704. The chamber formed between the panes may further be subdivided into a plurality of compartmentalized zones 720 (or 820, 920, 1020) using internal barriers 722 (or 822), or partitions or similar structures. Such zoning may allow airflow within the chambers to be independently distributed or controlled across different regions of the surface to improve removal of precipitation, debris, or other contaminants.

In certain embodiments, each zone may be fluidly connected to an air supply source, such as an air compressor, through one or more ports 716 (or 916, 1116) or conduits or similar airflow pathways configured to deliver pressurized air to the respective zone. The chambers and zones may be dimensioned and arranged to distribute pressurized air across the surface in a controlled manner. For example, system 100 may regulate airflow characteristics including pressure, velocity, compression, expansion, and turbulence of the airflow within the chambers and zones, thereby enabling focused airflow or varying airflow patterns (e.g., shorter or longer turbulent flow paths) directed toward outer surface 102a.

In some embodiments, internal passages may also be provided to distribute pressurized air within the chambers and across the zones. For example, certain zones may not be positioned directly adjacent to an edge or side of the pane through which pressurized air is initially supplied. In such embodiments, tunnels 1024 or channels, conduits, or other internal passageways may be provided between or within the panes to direct pressurized air from the air supply location to interior zones of a chamber. These passageways may extend through faces of the panes or along the chamber in a generally parallel direction relative to the panes to ensure that pressurized air can be delivered throughout the chamber and expelled through the through-holes of outer surface 102a.

In some embodiments, ports 716 or channels, conduits, or other passageways may also be provided between or within the panes to direct pressurized air from an air supply location and/or from an inner chamber to one or more additional chambers positioned further outward, toward outer surface 102a. For example, such passageways may allow pressurized air to travel from a first chamber to a second chamber located closer to outer surface 102a. These passageways may extend through faces of the panes or along the chambers to ensure that pressurized air can be delivered throughout the chambers and ultimately expelled through the through-holes of outer surface 102a.

In some embodiments, airflow between zones may also be controlled by pressure responsive valves or air lock structures configured to selectively permit airflow between adjacent zones. During normal operation, the pressure within each zone may maintain such valves in a closed position, thereby isolating the zones from one another. If a pressure drop or malfunction occurs in a particular zone, the resulting pressure differential may cause one or more valves to open, allowing pressurized air from neighboring zones to flow into the affected zone and maintain airflow across the surface. Suitable structures for such pressure responsive valves may include, for example, diaphragm valves, check valves, flap valves, swing valves, reed valves, or other one-way flow control devices.

FIGS. 1-11 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A windshield system for keeping debris away or removing debris from the windshield, the system comprising:
an outer glass surface of the windshield having a first shape and comprising a plurality of micro-holes therethrough;
a solid inner glass surface of the windshield having a second shape substantially the same as the first shape, the solid inner surface being positioned behind the outer surface and sealably connected to the outer surface along each of a plurality of edges to form one or more sealed chambers between the outer and solid inner surfaces such that air between the outer and inner windshield surfaces can only escape through the micro-holes; and
one or more openings on a given one of the plurality of edges, wherein the one or more openings are configured to accept one or more nozzles to supply the one or more sealed chambers with pressurized air which is forced through the micro-holes to thereby force debris away from or off the outer surface.

2. The windshield system of claim 1, wherein the pressurized air flows into the one or more chambers and out through the plurality of micro-holes, forming a barrier layer of pressurized air surrounding the outer surface.

3. The windshield system of claim 1, wherein the micro-holes each has a diameter between 50 μm to 500 μm and wherein the outer surface further comprises a plurality of macro-holes therethrough each having a diameter between 550 μm to 1000 μm.

4. The windshield system of claim 1, wherein the windshield system comprises a plurality of sealed chambers and a plurality of nozzles, each nozzle being configured to supply pressurized air to a respective one of the sealed chambers.

5. The windshield system of claim 1, further comprising a sensor positioned on or near the windshield to detect debris on or in proximity to the outer surface of the windshield, and wherein the pressurized air is automatically pumped through the one or more nozzles via an air pump coupled to the one or more nozzles based on the sensor's detection of debris on or in proximity to the outer surface.

6. The windshield system of claim 5, comprising a plurality of sensors positioned at different locations on or near the windshield to detect debris on or in proximity to the outer surface of the windshield at the different locations.

7. The windshield system of claim 5, wherein the sensor is configured to detect an amount of debris on or in proximity to the outer surface, and wherein the pressurized air is supplied at varying speeds and/or pressures in response to the amount of debris detected by the sensor.

8. The windshield system of claim 5, wherein the sensor is configured to detect precipitation on or in proximity to the outer surface, and wherein the pressurized air is selectively heated or cooled to facilitate removal of precipitation from the outer surface.

9. A windshield system for keeping debris away or removing debris from the windshield, the system comprising:
an outer glass surface of the windshield having a first shape and comprising a plurality of through-holes;
a solid inner glass surface of the windshield having a second shape substantially the same as the first shape, the solid inner surface being positioned behind the outer surface and sealably connected to the outer surface along each of a plurality of edges to form one or more sealed chambers between the outer and solid inner surfaces such that air between the outer and inner windshield surfaces can only escape through the through-holes; and
an air pump coupled to one or more nozzles, the one or more nozzles being situated in one or more openings on a given one of the plurality of edges, wherein the air pump is configured to supply pressurized air to the one or more sealed chambers through the one or more nozzles such that the pressurized air is forced through the through-holes to thereby force debris away from or off the outer surface.

10. The windshield system of claim 9, wherein the plurality of through-holes comprises a plurality of micro-through-holes each having a diameter between 50 μm to 500 μm and/or a plurality of macro-through-holes each having a diameter between 550 μm to 1000 μm.

11. The windshield system of claim 10, wherein the windshield system comprises a plurality of sealed chambers and a plurality of nozzles, each nozzle being configured to supply pressurized air to a respective one of the sealed chambers.

12. The windshield system of claim 9, wherein the pressurized air flows into the one or more chambers and out through the plurality of through-holes, forming a barrier layer of pressurized air surrounding the outer surface.

13. The windshield system of claim 9, further comprising a sensor positioned on or near the windshield to detect debris on or in proximity to the outer surface of the windshield, and wherein the pressurized air is automatically pumped through the one or more nozzles based on the sensor's detection of debris on or in proximity to the outer surface.

14. The windshield system of claim 13, comprising a plurality of sensors positioned at different locations on or near the windshield to detect debris on or in proximity to the outer surface of the windshield at the different locations.

15. The windshield system of claim 13, wherein the sensor is configured to detect precipitation on or in proximity to the outer surface, and wherein the pressurized air is selectively heated or cooled to facilitate removal of precipitation the outer surface.

16. The windshield system of claim 13, wherein the sensor is configured to detect an amount of debris on or in proximity to the outer surface, and wherein the air pump is automatically activated in response to the amount of debris detected by the sensor.

17. The windshield system of claim 13, wherein the sensor is configured to detect an amount of debris on or in proximity to the outer surface, and wherein the pressurized air is supplied at varying speeds and/or pressures in response to the amount of debris detected by the sensor.

18. A method for keeping debris away or removing debris from a windshield, the method comprising:
detecting, by a sensor positioned on or near the windshield, an amount of debris on or in proximity to an outer glass surface of the windshield, wherein the outer surface comprises a plurality of micro-holes therethrough and wherein the outer surface is sealably connected to a solid inner glass surface along each of a plurality of edges to form one or more sealed chambers between the outer and solid inner surfaces such that air between the outer and inner windshield surfaces can only escape through the micro-holes;
determining, by a controller, that the amount of debris meets a given threshold;
activating, by the controller, an air pump based at least on the determination, the air pump being coupled to one or more nozzles, the one or more nozzles being situated in one or more openings on a given one of the plurality of edges; and
supplying, by the air pump, pressurized air into the one or more sealed chambers and out through the micro-holes to form a barrier layer of pressurized air on the outer surface.

19. The method of claim 18, wherein detecting the amount of debris on or in proximity to the outer glass surface comprises detecting an amount of debris on or in proximity to an outer glass surface, the outer glass surface comprising a plurality of micro-holes therethrough each having a diameter between 50 μm to 500 μm.

20. The method of claim 18, wherein detecting the amount of debris on or in proximity to the outer glass surface comprises detecting an amount of debris on or in proximity to an outer glass surface having a first shape, the outer surface being sealably connected to a solid inner glass surface having a second shape substantially the same as the first shape, the solid inner surface being positioned behind the outer surface.
